(19) United States
(12) Patent Application Publication
(10) Pub. No.: US 2026/0234992 A1
(43) Pub. Date: Aug. 13, 2026

(54) METHOD FOR MANUFACTURING AN OPTIMAL TORSION SPRING, METHOD FOR ASSEMBLING A SPRING-ASSISTED ROLLER BLIND MECHANISM AND CORRESPONDING SPRING-ASSISTED ROLLER

(71) Applicant: 7912854 CANADA INC., Terrebonne (CA)

(72) Inventors: Augustin ARCHAMBAULT, Stoke (CA); Alain FRANCOEUR, Sainte-Anne-des-Plaines (CA); Danny PARKER, Mascouche (CA)

(21) Appl. No.: 19/153,977

(22) PCT Filed: Feb. 6, 2024
(86) PCT No.: PCT/CA2024/050143

§ 371 Date: Aug. 6, 2025

Related U.S. Application Data
(60) Provisional application No. 63/484,035, filed on Feb. 9, 2023.

(51) Int. Cl. E06B 9/42; B21F 3/02; E06B 9/60

(52) U.S. Cl. CPC E06B 9/42; B21F 3/02; E06B 9/60

(57) ABSTRACT

A method for assembling a spring-assisted roller blind mechanism for a roller blind system including a roller blind tube assembly with a roller blind tube and a blind mounted thereto, the mechanism being operatively couplable to the roller blind tube to configure the blind in wound and unwound configurations. The method includes determining an optimal spring feature as a function of at least one blind parameter of the roller blind system, selecting a torsion spring as a function of the determined optimal spring feature, and determining an installation length of the selected torsion spring. The method further includes substantially conforming a length of the selected torsion spring to the determined installation length to provide an adjusted torsion spring, and at least partially engaging a first end portion of the adjusted torsion spring to a spring-engaging portion of the roller blind mechanism to assemble the spring-assisted roller blind mechanism.

This application is a national stage filing of International (PCT) application No. PCT/CA2024/050143 filed on Feb. 6, 2024 and entitled METHOD FOR MANUFACTURING AN OPTIMAL TORSION SPRING, METHOD FOR ASSEMBLING A SPRING-ASSISTED ROLLER BLIND MECHANISM AND CORRESPONDING SPRING-ASSISTED ROLLER BLIND MECHANISM, to International Publication No. WO 2024/164072, which in turn claims priority to U.S. provisional patent application No. 63/484,035, filed on Feb. 9, 2023, and entitled METHOD FOR MANUFACTURING AN OPTIMAL TORSION SPRING, METHOD FOR ASSEMBLING A SPRING-ASSISTED ROLLER BLIND MECHANISM AND CORRESPONDING SPRING-ASSISTED ROLLER BLIND MECHANISM. The entire contents of both of those applications are hereby incorporated by reference herein.

### TECHNICAL FIELD

The technical field of the current application relates to roller blind mechanisms comprising a spring, and more particularly to roller blind mechanisms with a length-adjusted torsion spring and to corresponding assembling methods.

### BACKGROUND

Roller blind mechanisms often comprise a spring, such as for instance a helical torsion spring, which is configured to assist at least one of a winding and an unwinding of a blind configurable into wound and unwound configurations upon actuation of the roller blind mechanism.

However, parameters of the spring, such as for instance a spring constant thereof, have to be chosen accurately, as a function of different parameters of the roller blind mechanisms and of the roller blind systems equipped therewith. The spring constant can depend for instance on said following parameters: a wire diameter (i.e., a diameter of the wire at least partially forming the spring), a coil diameter (i.e., an average outer diameter of the coils forming the spring), a tightness of the coils (i.e., an average distance between adjacent coils forming the spring) and a length, or free length (i.e., a length of the spring when at rest).

During the production of made-to-measure or tailored-made blinds, a problem facing roller blind manufacturers has been to provide customized roller blinds with optimized spring-assisted mechanisms. Indeed, any new set of dimensions for a specific blind requires a suitable spring that will properly operate the blind. For these reasons, roller blind manufacturers have been led to manage large inventories of springs,

### SUMMARY

It may be desired to provide tailored roller blinds (i.e., with precise dimensions in accordance with the specifications of the end customers), with springs substantially fitting for the blind, and to provide a method to configure a roller blind spring in accordance with customized specifications.

It is therefore an aim of the present disclosure to at least partially address the above-mentioned issues.

According to a general aspect, there is provided a method for assembling a spring-assisted roller blind mechanism for a roller blind system comprising a roller blind tube assembly, the roller blind tube assembly comprising a roller blind tube and a blind mounted thereto, the spring-assisted roller blind mechanism comprising a spring-engaging portion and being operatively couplable to the roller blind tube to configure the blind in wound and unwound configurations, the method comprising: determining at least one optimal spring feature as a function of at least one blind parameter of the roller blind system; selecting a torsion spring as a function of said at least one determined optimal spring feature; determining an installation length of the selected torsion spring; substantially conforming a length of the selected torsion spring to the determined installation length to provide an adjusted torsion spring; and at least partially engaging a first end portion of the adjusted torsion spring to said spring-engaging portion to assemble the spring-assisted roller blind mechanism.

According to another general aspect, there is provided a method for manufacturing an optimal torsion spring for a spring-assisted roller blind mechanism of a roller blind system, the method comprising: determining at least one optimal spring feature as a function of at least one blind parameter of the roller blind system; selecting a wire as a function of said at least one determined optimal spring feature; and coiling the selected wire so as to form the optimal torsion spring.

According to another general aspect, there is provided a method for assembling the spring-assisted roller blind mechanism of said roller blind system, the spring-assisted roller blind mechanism comprising a spring-engaging portion, the method comprising: providing an optimal torsion spring manufactured according to the present disclosure; and at least partially engaging a first end portion of the optimal torsion spring to said spring-engaging portion to assemble the spring-assisted roller blind mechanism.

According to another general aspect, there is provided a method for assembling a spring-assisted roller blind mechanism for a roller blind system comprising a roller blind tube assembly, the roller blind tube assembly comprising a roller blind tube and a blind mounted thereto, the spring-assisted roller blind mechanism comprising a spring-engaging portion and being operatively couplable to the roller blind tube to configure the blind in wound and unwound configurations, the method comprising: determining at least one optimal spring feature as a function of at least one blind parameter of the roller blind system; determining a spring length; providing a plurality of torsion springs; selecting a torsion spring within said plurality of torsion springs as a function of said at least one determined optimal spring feature and said determined spring length; at least partially engaging a first end portion of the adjusted torsion spring to said spring-engaging portion to assemble the spring-assisted roller blind mechanism.

### BRIEF DESCRIPTION OF THE DRAWINGS

FIG. 1 is a front perspective view, partially exploded, of a roller blind system comprising a roller blind tube assembly and a spring-assisted roller blind mechanism in accordance with an embodiment, the spring-assisted roller blind mechanism comprising a roller blind mechanism with a torsion spring.

FIG. 2 is a perspective view of the spring-assisted roller blind mechanism of FIG. 1.

FIG. 3 is a partially exploded view of a roller blind system in accordance with another embodiment.

FIG. 4 is a sectional view of the roller blind system of FIG. 3;

FIG. 5 is a front perspective view of a roller blind system in accordance with another embodiment.

FIG. 6 is a cross-section view of the roller blind mechanism of FIG. 5; and

FIG. 7 is a schematic representation of a method for graphically determining at least one optimal spring feature of a spring of a spring-assisted roller blind mechanism.

### DETAILED DESCRIPTION

In the following description, the same numerical references refer to similar elements.

Furthermore, for the sake of simplicity and clarity, namely so as to not unduly burden the figures with several references numbers, not all figures contain references to all the components and features, and references to some components and features may be found in only one figure, and components and features of the present disclosure which are illustrated in other figures can be easily inferred therefrom. The embodiments, geometrical configurations, materials mentioned and/or dimensions shown in the figures are optional and are given for exemplification purposes only.

Moreover, it will be appreciated that positional descriptions such as “above”, “below”, “forward”, “rearward”, “left”, “right” and the like should, unless otherwise indicated, be taken in the context of the figures only and should not be considered limiting. Moreover, the figures are meant to be illustrative of certain characteristics of the roller blind system and components thereof and are not necessarily to scale.

To provide a more concise description, some of the quantitative expressions given herein may be qualified with the term “about”. It is understood that whether the term “about” is used explicitly or not, every quantity given herein is meant to refer to an actual given value, and it is also meant to refer to the approximation to such given value that would reasonably be inferred based on the ordinary skill in the art, including approximations due to the experimental and/or measurement conditions for such given value.

In the following description, an embodiment is an example or implementation. The various appearances of “one embodiment”, “an embodiment” or “some embodiments” do not necessarily all refer to the same embodiments. Although various features may be described in the context of a single embodiment, the features may also be provided separately or in any suitable combination. Conversely, although the invention may be described herein in the context of separate embodiments for clarity, it may also be implemented in a single embodiment. Reference in the specification to “some embodiments”, “an embodiment”, “one embodiment” or “other embodiments” means that a particular feature, structure, or characteristic described in connection with the embodiments is included in at least some embodiments, but not necessarily all embodiments.

It is to be understood that the phraseology and terminology employed herein is not to be construed as limiting and are for descriptive purpose only. The principles and uses of the teachings of the present disclosure may be better understood with reference to the accompanying description, figures and examples. It is to be understood that the details set forth herein do not construe a limitation to an application of the disclosure.

Furthermore, it is to be understood that the disclosure can be carried out or practiced in various ways and that the disclosure can be implemented in embodiments other than the ones outlined in the description above. It is to be understood that the terms “including”, “comprising”, and grammatical variants thereof do not preclude the addition of one or more components, features, steps, or integers or groups thereof and that the terms are to be construed as specifying components, features, steps or integers. If the specification or claims refer to “an additional” element, that does not preclude there being more than one of the additional elements. It is to be understood that where the claims or specification refer to “a” or “an” element, such reference is not to be construed that there is only one of that elements. It is to be understood that where the specification states that a component, feature, structure, or characteristic “may”, “might”, “can” or “could” be included, that particular component, feature, structure, or characteristic is not required to be included.

The descriptions, examples, methods and materials presented in the claims and the specification are not to be construed as limiting but rather as illustrative only. Meanings of technical and scientific terms used herein are to be commonly understood as by one of ordinary skill in the art to which the invention belongs, unless otherwise defined. It will be appreciated that the methods described herein may be performed in the described order, or in any suitable order.

Referring now to the drawings, there is shown a roller blind system 10 comprising a roller blind tube assembly 50 and a spring-assisted roller blind mechanism 100. For clarity purposes, only a portion of the roller blind system 10 is illustrated. Possible non-limitative embodiments of a roller blind system are disclosed in PCT International Publication No. WO 2020/160651 filed by the applicant, the disclosure of which is hereby incorporated by reference in its entirety.

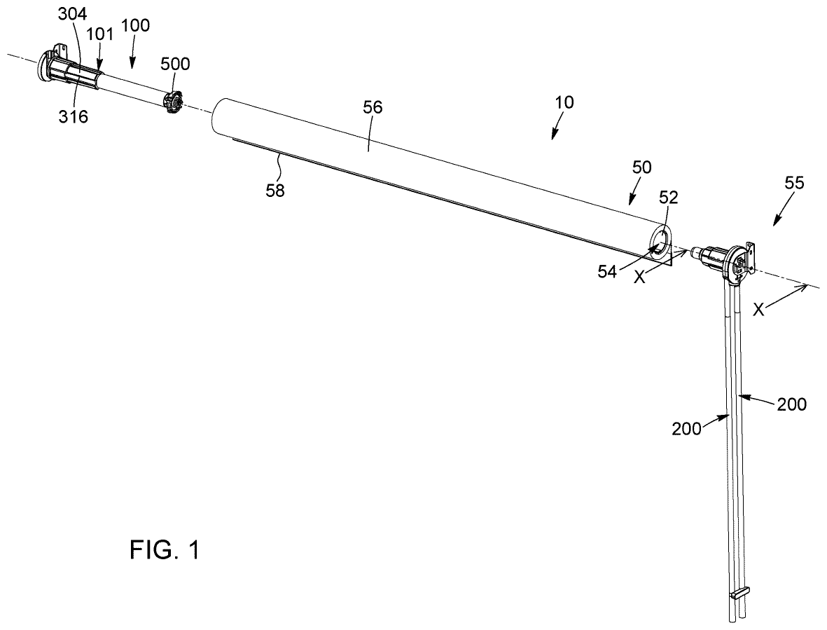

Still referring to FIG. 1, the roller blind tube assembly 50 comprises a roller blind tube 52 defining a mechanism-receiving cavity 54. Moreover, a blind 56 (or window covering 56, or shade 56), for instance at least partially made of fabric or of one or more layers of a flexible element, is mounted to the roller blind tube 52 and is at least partially wrapped around the roller blind tube 52. The blind 56 comprises, in the embodiment shown, a weight bar 58 secured to a bottom edge of the blind 56 to maintain the blind in a substantially vertical configuration when the blind 56 is in an unwound configuration (or extended configuration), for instance for the blind to at least partially cover a window.

The roller blind system 10 further comprises a roller blind actuation assembly 55 configured to cooperate with the roller blind tube 52 and the spring-assisted roller blind mechanism 100 to extend and retract the blind 56 (i.e., to configure the blind into unwound and wound configurations). In other words, the roller blind actuation assembly 55 (or roller blind actuator 55) cooperates (i.e., is operatively coupled) with the roller blind tube assembly 50 (for instance with the roller blind tube 52 thereof) to configure the blind 56 either in the unwound configuration (or extended configuration), or in the wound configuration, in which the blind 56 is at least partially wrapped around the roller blind tube 52 and wherein the bottom edge is in an upper end position. The roller blind actuation assembly 55 is also configured to cooperate with the roller blind tube 52 to configure the blind 56 in any intermediate position between the extended and retracted configurations. The roller blind actuation assembly 55 could also be used with a roller blind system of the free-lift style (i.e., actuated directly by a user pulling or pushing the bottom edge or any other part of the blind 56).

In the embodiment shown, the roller blind actuation assembly 55 comprises first and second roller blind actuation cables (or first and second flexible roller blind-actuating elements), for instance at least partially enclosed in first and second cable-covering assemblies 200, in the embodiment shown). The first and second actuation cables are operatively coupled to the roller blind tube assembly 50 to configure the blind 56 from one of the wound and unwound configurations- or any intermediate configuration-into the other one of the wound and unwound configurations- or in any other intermediate configuration-upon pulling on one of the first and second roller blind actuation cables.

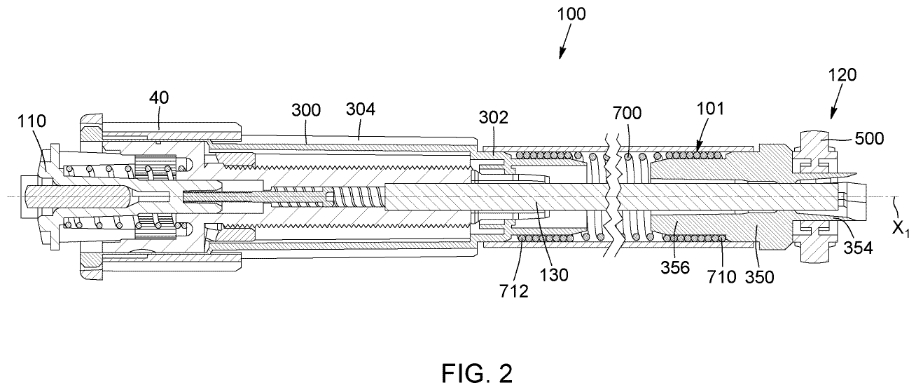

As best shown in FIG. 2, the spring-assisted roller blind mechanism 100 comprises a spring-assisted roller blind tube-supporting assembly 101 comprising a biasing member 700 (or torsion spring 700, or helical torsion spring 700 in the embodiment shown) configured to store energy when the tube-supporting assembly 101 is actuated (for instance by exerting a pulling force on the corresponding one of the first and second roller blind actuation cables), for instance to store energy when the blind 56 is unwound, and to assist the actuator 55 and/or to ease the displacement of the blind 56 for it to be retracted toward an upper end position.

The tube-supporting assembly 101 is configured to support a portion of the roller blind tube 52 (for instance a first end portion of the roller blind tube 52 opposed to a second end portion cooperating with the roller blind actuator 55). In the embodiment shown, the tube-supporting assembly 101 is at least partially insertable- or engageable-into the mechanism-receiving cavity 54 of the roller blind tube 52. The tube-supporting assembly 101 of the spring-assisted roller blind mechanism 100 comprises a support-mounting extremity 110, fixedly mountable to a holding element or holding surface or roller blind support (for instance a building structure), and an opposed free extremity 120, extending in the mechanism-receiving cavity 54 when the tube-supporting assembly 101 is inserted therein. The tube-supporting assembly 101 defines a first axis X (or longitudinal axis X or longitudinal direction) and comprises a shaft 130 (or coupling shaft 130 or angularly coupling shaft 130) extending along the first axis X between the support-mounting extremity 110 and the free extremity 120.

The tube-supporting assembly 101 further comprises a bearing sleeve 300 extending along the first axis X and comprising a spring-receiving end 302 (or spring-supporting end 302, or torsion spring-mounting end 302), at a distal end thereof, and a bearing body 304 having an outer surface with angular couplers 316 (FIG. 1) formed thereon and dimensioned to cooperate with corresponding angular couplers formed in an inner surface of the roller blind tube 52, so that when the tube-supporting assembly 101 is inserted into the mechanism-receiving cavity 54, the bearing sleeve 300 and the roller blind tube 52 are angularly coupled to each other upon rotation of the bearing sleeve 300 about the first axis X. In other words, the bearing sleeve 300 is shaped and dimensioned to be rotated about the first axis X when the roller blind tube 52 is rotated about the first axis X.

The tube-supporting assembly 101 further comprises a spring-supporting sleeve 350 located at the free extremity 120 of the tube-supporting assembly 101. In the embodiment shown, the spring-supporting sleeve 350 extends along the first axis X. A shaft-receiving cavity is formed therein and is shaped and dimensioned to prevent the spring-supporting sleeve 350 from pivoting about the coupling shaft 130 received therein upon rotation of the roller blind tube 52 about the first axis X. The spring-supporting sleeve 350 has a support-mounting end portion 354 at a distal end thereof and a spring-supporting portion 356 at a proximal end thereof.

As mentioned above, the torsion spring 700 is configured to store energy when the roller blind tube assembly 50 is unwound (i.e. when the roller blind 56 is extended), and to ease the winding of the roller blind tube assembly 50 (i.e., to ease the winding—for instance of the fabric secured to the roller blind tube 52—of the roller blind tube assembly 50, i.e., to ease the configuration of the roller blind 56 into the retracted configuration or into any intermediate configuration between the extended configuration and the retracted configuration). The torsion spring 700 might also be referred to as a balance spring as it is configured to substantially balance—or substantially compensate—the torque applied to the roller blind tube 52 due to the weight of the fabric 56 (or blind 56) for the different vertical positions of the lower edge thereof between the wound and unwound configurations of the roller blind tube assembly 50 (i.e., between the retracted and the extended configurations of the blind 56). As represented for instance in FIG. 2, the helical torsion spring 700 extends along the first axis X and surrounds at least partially the shaft 130. The torsion spring 700 comprises a first fixed end portion 710 (or distal end portion 710) engaged with the spring-supporting portion 356 of the spring-supporting sleeve 350, and an opposed rotatable end portion 712 (or proximal distal end portion 712) engaged with the spring-receiving end 302 (on an outer surface thereof) of the bearing sleeve 300.

It is thus understood that when the roller blind tube 52 is pivoted about the first axis X to extend the roller blind 56 (for instance upon actuation of the actuator 55 to extend the roller blind 56), the torsion spring 700 is tensed or loaded and stores energy. Reversely, when the roller blind tube 52 is pivoted about the first axis X to retract the roller blind 56 (for instance upon actuation of the actuator 55 to retract the roller blind 56), the torsion spring 700 extends and releases the stored energy.

It is understood that the helical torsion spring 700 can be preloaded prior to the installation of the spring-assisted roller blind mechanism 100 in the mechanism-receiving cavity 54 of the roller blind tube 52.

The tube-supporting assembly 101 of the spring-assisted roller blind mechanism 100 further comprises a support-mounting sleeve 40 having for instance a substantially cylindrical shape. The support-mounting sleeve 40 has a bearing sleeve-receiving cavity formed therein that is shaped and dimensioned to receive at least partially the bearing sleeve 300. It is thus understood that the support-mounting sleeve 40 is shaped and dimensioned to form an interface, considered in a radial direction (i.e., substantially perpendicularly to the longitudinal axis X) between the bearing sleeve 300 and the roller blind tube 52.

The tube-supporting assembly 101 also comprises a rotation bearing 500 having an outer surface with angular couplers 502 formed thereon, that are configured to cooperate with corresponding angular couplers formed on the inner surface of the roller blind tube 52 so that when the tube-supporting assembly 101 is inserted into the mechanism-receiving cavity 54, the rotation bearing 500 and the roller blind tube 52 are angularly coupled to each other upon rotation of the roller blind tube 52 about the first axis X (for instance upon actuation of the actuator 55). The rotation bearing 500 is thus configured to contribute to maintaining the tube-supporting assembly 101 within the mechanism-receiving cavity 54 formed in the roller blind tube 52.

In the first embodiment shown, it is thus understood that the spring-assisted roller blind mechanism 100 is arranged at a first side of the roller blind tube 52, whereas the roller blind system 10 comprises the above-mentioned roller blind actuation assembly 55 (comprising first and second roller blind actuation cables, for instance enclosed in first and second cable-covering assemblies or comprising first and second chain portions or any other suitable actuating means) arranged at a second opposed side of the roller blind tube.

It is appreciated that the shape and the configuration of the roller blind system comprising a spring-assisted roller blind mechanism can vary from the embodiment shown.

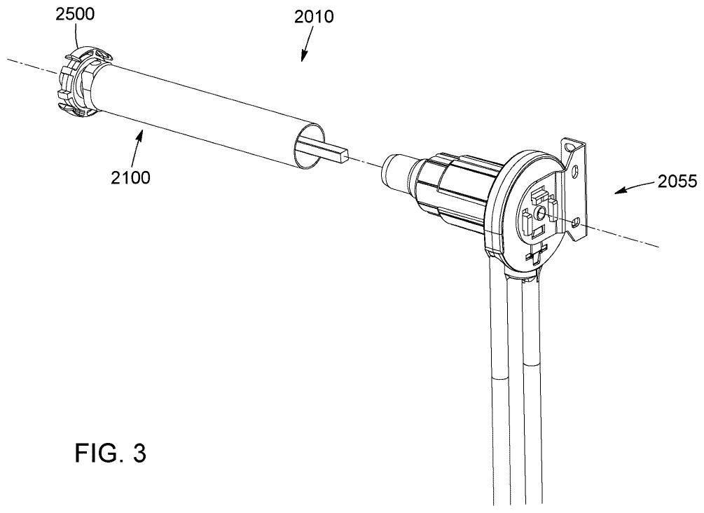

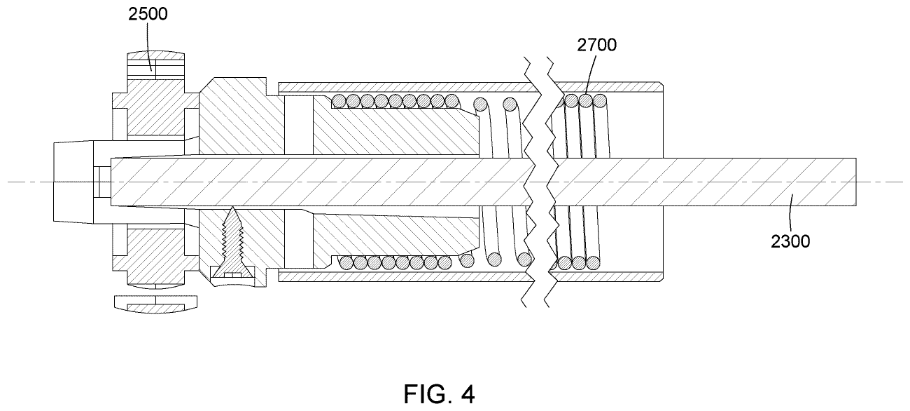

FIGS. 3 and 4 represent another possible embodiment of a roller blind system 2010 comprising a spring assisted roller blind mechanism 2100 shaped and dimensioned to be used as a plug in with an existing roller blind actuation assembly 2055, the spring-assisted roller blind mechanism 2100 being couplable to an end portion of the roller blind actuation assembly 2055. Similar to the first embodiment, the spring-assisted roller blind mechanism 2100 comprises a helical torsion spring 2700 at least partially surrounding a mechanism shaft 2300, and a rotation bearing 2500 angularly couplable with a roller blind tube of a roller blind tube assembly.

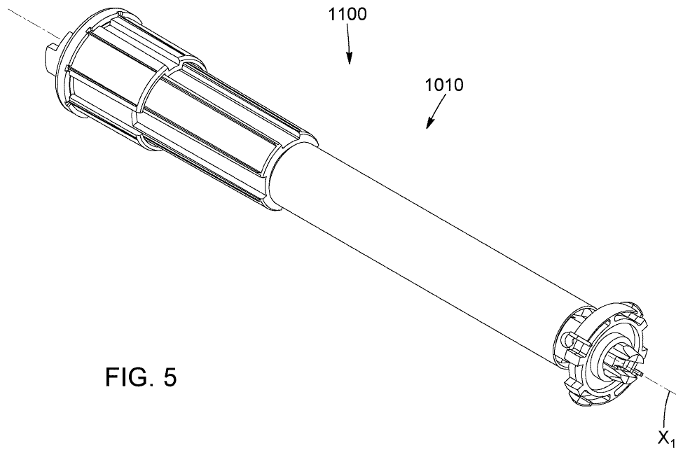

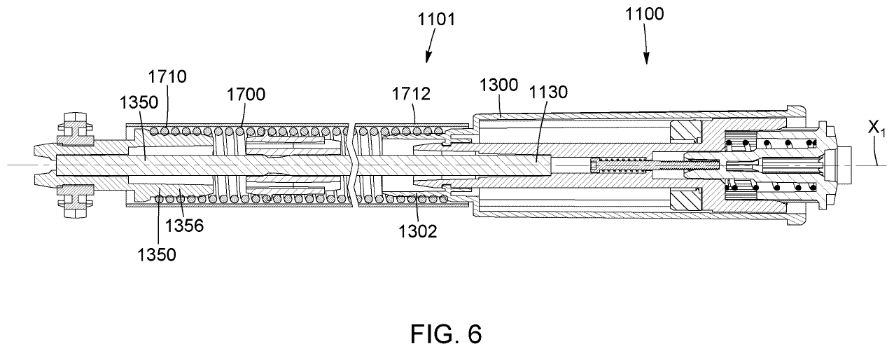

FIGS. 5 and 6 represent another possible embodiment of a roller blind system 1010, comprising another possible embodiment of spring-assisted roller blind mechanism 1100 comprising a tube-supporting assembly 1101. Possible embodiments of the spring-assisted roller blind mechanism 1100 are disclosed in PCT International Publication No. WO2020/132750, also filed by the applicant, the disclosure of which is hereby incorporated by reference in its entirety.

The tube-supporting assembly 1101 comprises a torsion spring 1700 (or biasing member 1700, or helical torsion spring 1700), which is configured to store energy when the roller blind tube assembly is unwound and to ease the winding of the roller blind tube assembly.

As represented for instance in FIG. 6 and similar to the first embodiment described with reference to FIGS. 1 to 3, the helical torsion spring 1700 extends along a first axis X and surrounds at least partially a shaft 1130. The torsion spring 1700 comprises a first fixed end portion 1710 (or distal end portion 1710) engaged with a spring-supporting portion 1356 of a spring-supporting sleeve 1350, and an opposed rotatable end portion 1712 (or proximal distal end portion 1712) engaged with a spring-receiving end 1302 (on an outer surface thereof) of a bearing sleeve 1300. It is thus understood that when the roller blind tube is pivoted about the first axis to extend the roller blind (for instance upon actuation of the roller blind actuation mechanism to extend the roller blind 56), the torsion spring 1700 is tensed or loaded and stores energy. Reversely, when the roller blind tube 52 is pivoted about the first axis X to retract the roller blind 56 (for instance upon actuation of the roller blind actuation mechanism to retract the roller blind 56), the torsion spring 1700 extends and releases the stored energy.

It is appreciated that the shape and the configuration of the spring assisted roller blind mechanism comprising at least one torsion spring, and the shape, the configuration and the relative arrangement of the components thereof can vary from the embodiments briefly shown above.

It could be conceived for instance a roller blind system with a roller blind tube assembly having a first free end portion or a bearing arranged at the first end portion, and further comprising a spring-assisted roller blind mechanism at an opposed second end portion; such roller blind systems are usually known as free-lift systems or can be actuated by pulling and/or pushing a weight bar of the roller blind tube assembly.

It could also be conceived a roller blind system with a first spring-assisted roller blind mechanism arranged in combination with a roller blind actuation assembly at a first end portion of the roller blind tube assembly, and with a second spring-assisted roller blind mechanism arranged at an opposed second end portion of the roller blind tube assembly. In other words, the roller blind system could comprise first and second balance springs respectively at the first and second end portions of the roller blind tube assembly. The spring-assisted roller blind mechanism could also be used in cooperation with an engine-drive (or engine-assisted) roller blind actuation assembly. The spring-assisted roller blind mechanism could also be used in combination with a roller blind breaking module.

### Method for Assembling a Spring-assisted Roller Blind Mechanism

It is known that spring parameters of the torsion spring 700, 1700, 2700 (such as for instance a spring constant (k) thereof) have to be chosen as a function of at least one of blind parameters of the roller blind system 10 (for instance of at least one of parameters of the roller blind tube assembly 50 thereof) and as a function of the different configurations thereof between the wound configuration and the unwound configuration (i.e., for the different configurations of the blind 56 between the retracted and the extended configurations, i.e., between the upper and lower end positions thereof). In other words, the spring parameters of the torsion spring 700, 1700, 2700 have to be chosen as a function of the torque applied to the roller blind tube 52 by the blind 56 (or fabric 56) comprising for instance the weight bar 58.

The present disclosure thus concerns a method for assembling a spring-assisted roller blind mechanism for a roller blind system comprising a roller blind tube assembly, the roller blind tube assembly comprising a roller blind tube and a blind mounted thereto, the spring-assisted roller blind mechanism comprising a spring-engaging portion and being operatively couplable to the roller blind tube to configure the blind in wound and unwound configurations. The method might concern a torsion spring of one of the different possible embodiments of roller blind mechanisms briefly disclosed above, or any other spring-assisted roller blind mechanism comprising a spring-engaging portion, and a torsion spring at least partially engaged with the spring-engaging portion.

It is well known to the person skilled in the art that the spring constant and a length of a spring are inversely proportional, meaning that if the length of the spring is increased, the spring constant thereof decreases. The length of the spring also determines the maximum number of rotations a roller blind tube of a roller blind tube assembly will be able to make, which in turn dictates at least one of the upper and lower positions of the blind thereof.

In the embodiment shown, the method comprises a step of determining at least one optimal spring feature as a function of at least one blind parameter of the roller blind system; a step of selecting a torsion spring as a function of said at least one determined optimal spring feature; a step of determining an installation length of the selected torsion spring; a step of substantially conforming a length of the selected torsion spring to the determined installation length to provide an adjusted torsion spring; and a step of at least partially engaging a first end portion of the adjusted torsion spring to said spring-engaging portion to assemble the spring-assisted roller blind mechanism.

### Step of Determining at Least One Optimal Spring Feature As a Function of at Least One Blind Parameter of the Roller Blind System

For instance, the step of determining optimal spring features comprises a step of determining an optimal spring stiffness and/or a step of determining an optimal spring preload as a function of at least one blind parameter.

For instance and without being limitative, the at least one blind parameter as a function of which the optimal spring feature of the torsion spring is selected comprises at least one of a length of the roller blind tube assembly, an outer diameter of the roller blind tube, an inner diameter of the roller blind tube, at least one blind parameter of the blind, a weight of the roller blind tube assembly, a linear weight of a basis or weight bar of the roller blind tube assembly, a number of rotations of said roller blind tube to be configured from one of the unwound and wound configurations to the other, a roll diameter of the roller blind tube (varying as a function of a ratio of the blind being rolled around the roller blind tube), a desired behavior of the roller blind tube assembly (for instance with respect to a sensibility or a reactivity of the roller blind tube assembly upon actuation of the roller blind system) or any combination thereof. For instance and without being limitative, the at least one blind parameter comprises at least one of a length, a width, a thickness, a surface weight of the blind and a material (or a weight thereof) at least partially forming the blind and the like.

As mentioned above, the objective of the torsion spring of the spring-assisted roller blind mechanism of the roller blind system is to at least partially counterbalance the torque exerted on the roller blind tube by the blind and blind weight. Therefore, for a given spring constant, a torsion spring will be considered “optimal” or substantially optimal in relation to a roller blind system if it provides the desired assisting torque (or a substantially satisfactory assisting torque).

Mathematical tools and models in which the spring length is set as a variable are known to the person skilled in the art to emulate the torque profile of a spring to match—or at least minimize a difference with—the torque on a blind mounted to a blind tube 52 with varying levels of complexity. Possible examples of such mathematical tools and systems are disclosed for instance and without being limitative in U.S. Pat. Nos. 10,221,622 or 10,030,442.

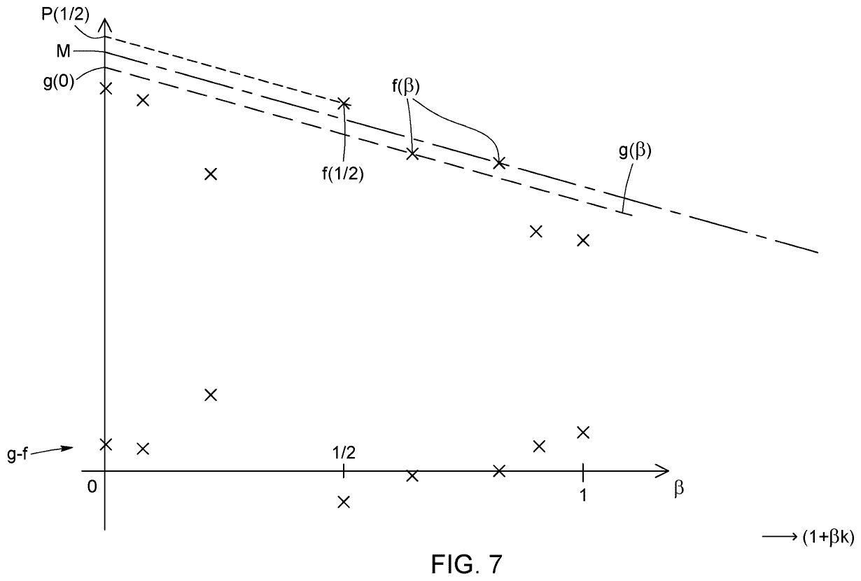

FIG. 7 represents a possible graphical method to determine an optimal spring torque and an optimal preload for a spring of said optimal spring torque.

For a given roller blind tube assembly of a given roller blind system, a variation f of the torque applied to the roller blind tube is represented as a function of an angular position of the roller blind tube around which a roller blind is more or less rolled (i.e., as a function of a vertical position of the lower edge of the roller blind). For instance, when β equals to 0, the roller blind tube assembly in the wound configuration, whereas when β equals to 1, the roller blind tube assembly in the unwound configuration. In the embodiment shown, f is represented as a scatter graph.

A line g is determined passing through or proximate f(0) and f(1); a slope of said line g corresponds to a stiffness of an optimal spring to substantially balance the torque applied to the roller blind tube. Different lines corresponding to different springs can be tested, in order to minimize a difference between f and g (as represented in the lower section of the graph of FIG. 7).

Said line g being determined, a value corresponding substantially to f(½) is projected along the slope of g onto the vertical axis (P(½)). M represented on the vertical axis is determined as being equidistant from P(½) and g(0). A projection on the horizontal axis of M along a direction parallel to the slope of g (dot-and-dash line, the intersection thereof with the horizontal axis being not represented) corresponds to the value (1+βk) where βk is the spring preload.

It is appreciated that other methods to determine at least one optimal spring feature could be used.

### Step of Selecting a Torsion Spring as a Function of the Determined Optimal Spring Feature

For instance, the selection of a torsion spring as a function of the determined optimal spring feature is performed via successive iterations taking into account available spring wires and/or available springs.

The step of providing the torsion spring might comprise a preliminary step of selecting the provided torsion spring within a range of available torsion springs, as a function of at least one of the blind parameters of the roller blind system (for instance of the roller blind tube assembly thereof). It is known that different types of springs, for instance torsion springs, are available on the market. For instance, round wire springs and spiral springs are possible torsion springs that can be used as balance springs for roller blind systems.

It is known that a torsion spring can be characterized by different features, such as, for instance and without being limitative, a spring length (for instance springs of a length allowing several adjusted springs to be formed with one single provided spring), a spring constant, a Young module, a diameter of a wire forming at least partially the torsion spring, a number of active coils of the torsion spring, a material forming at least partially the torsion spring, a spring inner diameter, a spring outer diameter, a length or space dimension between adjacent coils, a tension between adjacent coils, a winding direction of the spring (i.e., whether the wire is rotated in a clockwise or counter clockwise direction to form the spring) and the like.

Visual information could be provided on the available springs to ease their pre-selection. Moreover, in order to easily and visually validate a spring preload for a given spring, a line (for instance of a color corresponding to a specific stiffness) could be drawn or printed along the given spring: the shape of the line once the spring has been preloaded thus automatically inform the user of the spring preload applied to the spring.

For instance, the preliminary step of selecting the provided torsion spring might comprise a step of selecting a torsion spring having a coil inner diameter corresponding substantially to an outer cross-section of the spring-engaging portion of the at least one roller blind operating system. The preliminary step might also comprise a step of selecting a torsion spring having a coil outer diameter smaller or corresponding substantially to an inner diameter of a protection tube of the roller blind actuation mechanism. For instance, the preliminary step of selecting the provided torsion spring might comprise a step of selecting a torsion spring having a spring length as a function of at least one dimension of the roller blind actuation mechanism. The preliminary step might also comprise a step of selecting a torsion spring via a correlation table between a list of available torsion spring and one or more blind parameters of the roller blind tube assembly.

It is appreciated that the preliminary step might be a combination of the different above-mentioned pre-selection steps and/or of any other pre-selection steps.

For instance, the step of selecting the torsion spring as a function of said at least one determined optimal spring feature comprises verifying that the selected torsion spring complies with at least one predetermined criteria.

As mentioned above, the optimal spring is selected via successive iterations. For instance, once an optimal spring stiffness is determined, for a given wire, a spring is determined by calculating a number of coils required to provide the optimal spring stiffness. For the determined spring, a cost and a security breaking factor are determined. The final chosen spring will for instance be the one with the lower cost and with a satisfactory security breaking factor.

Additional verifications can be performed for each determined spring. For instance, if none of the determined springs has a satisfactory security breaking factor, compromises could be needed on the counterbalancing of the torque exerted on the roller blind tube. Such compromises might impact a spring preload or a spring length.

In case the determined spring has a length exceeding predetermined criteria (such as for instance dimensions of the roller blind tube assembly, a cost limit, production constraints and the like), other compromises could be needed on the counterbalancing of the torque exerted on the roller blind tube. Such compromises might impact a spring preload, a spring length and/or a wire diameter.

Compromises might also be needed with respect to the determined spring preload, for instance to take into account production constraints or in case a negative spring preload would have been determined.

### Step of Determining an Installation Length of the Selected Torsion Spring

For instance and without being limitative, the step of determining the installation length of the torsion spring comprises taking into account the spring constant of the selected torsion spring and said at least one parameter of the roller blind system (for instance the roller blind tube assembly 50 thereof). Step of substantially conforming the length of the selected torsion spring to the determined installation length to provide an adjusted torsion spring.

For instance and without being limitative, the step of substantially conforming the length of the torsion spring to the determined installation length comprises a step of splitting the selected torsion spring into an adjusted torsion spring portion and a residual portion. In other words, substantially confirming the length of the torsion spring to the determined installation length might comprise severing the provided torsion spring such that the spring is shortened to the determined optimal length. It is understood that a length of the torsion spring once substantially conformed to the determined installation length might be within a length range including the determined installation length. For instance, an absolute value of a difference between the determined installation length and the substantially conformed torsion spring length is smaller than about 5% of the determined installation length.

For instance, the conforming of the length of the selected torsion spring to the determined installation length might comprise a step of measuring a total length of the selected torsion spring for instance with an automatic digital stop (no marking of the spring needed) or a measuring tape (with a marking of the spring). The conforming then comprises cutting the selected torsion spring to the installation length for instance via a press and die system (in order to separate the coils and cut the wire in a substantially perpendicular direction relative to the wire direction), with cable and/or wire cutters (in order to manually cut the wire of the spring substantially perpendicularly to its direction), or with a cut-off wheel or any other suitable grinding methods.

In other embodiments, cutting the portion of the provided torsion spring comprises: marking a segment of a coil of the torsion spring at the determined installation length to identify a marked location of the spring to be cut; extending the torsion spring axially (i.e., in a direction substantially parallel to a central axis of the torsion spring) to expose the marked location of the spring and to partially separate the marked location from adjacent coils of the torsion spring; and cutting the torsion spring at the marked location. For instance, cutting or severing the torsion spring at the location of the marked coil segment comprises using a cut-off wheel, a torch or any other suitable device.

For instance and without being limitative, the cut portion of the coil of the torsion spring forms a plan substantially perpendicular to the central axis of the torsion spring. In another example, the cut portion of the coil of the torsion spring forms a plan substantially perpendicular to a longitudinal axis of the wire forming the coil in the vicinity of the cut portion. In another example, the step of substantially conforming the length of the torsion spring to the determined optimal length comprises forming a substantially rounded end portion of the torsion spring.

For instance, the spring-assisted roller blind mechanism has first and second spring-engaging portions, the method comprising engaging first and second opposed end portions of the adjusted torsion spring respectively to the first and second spring-engaging portions to assemble the roller blind actuation mechanism.

It should be understood that the present disclosure is not limited to a method comprising a step of substantially conforming a length of the selected torsion spring to the determined installation length to provide an adjusted torsion spring. The method could alternatively comprise a step of providing a plurality of torsion springs; a step of determining a spring length; and a step of selecting a torsion spring within said plurality of torsion springs as a function of said at least one determined optimal spring feature and said determined spring length. In other words, the method could comprise providing a variety of torsion springs of different lengths and different features, and selecting within said variety a torsion spring of a length and of features substantially conforming to the ones determined. For instance, the plurality of torsion springs comprises torsion springs of different lengths; for instance, a length difference between at least two of said plurality of torsion springs is smaller than about 1 inch, for instance smaller than about ½ inch, for instance smaller than about ¼ inch, for instance smaller than about ⅛ inch.

### Step of Engaging the Adjusted Torsion Spring to the Spring-Engaging Portion

For instance and without being limitative, the roller blind tube defines a mechanism-receiving cavity, and the method further comprises at least partially inserting the assembled roller blind mechanism into the mechanism-receiving cavity.

### Possible Benefits of the Method

It is thus understood that, according to the disclosed method, a minimum amount of material can be used to provide an adjusted and optimized spring-assisted roller blind mechanism. The method thus allows to reduce the number of articles in stock for assembling spring-assisted roller blind mechanisms.

It is also possible to optimize lengths of the springs in order to be more cost effective. A more accurate counter balancing is also made possible via the method, which is also made available for a broader scope of roller blind systems (for instance for roller blind systems, for instance for roller blinds thereof, having specific dimension constraints).

Moreover, it is understood that the method enables the use of different strategies as a function of a desired level of counter balancing, and not only as a constraint due to a limited selection of springs.

It is appreciated that the method and the different steps thereof can vary from the embodiment shown. For instance, it could be conceived a roller blind system with a roller blind actuation mechanism comprising two or more torsion springs, the method comprising substantially conforming a length of each of said two or more torsion springs to corresponding optimal lengths.
It should be understood that the present disclosure is not limited to a method for assembling a spring-assisted roller blind mechanism wherein the adjusted torsion spring would necessarily be formed by substantially conforming a length of a selected torsion spring to a determined installation length to provide an adjusted torsion spring.

### Method for Manufacturing an Optimal Torsion Spring for a Spring-Assisted Roller Blind Mechanism

The present disclosure also concerns a method for manufacturing an optimal torsion spring for a spring-assisted roller blind mechanism of a roller blind system, the method comprising: determining at least one optimal spring feature as a function of at least one blind parameter of the roller blind system; selecting a wire as a function of said at least one determined optimal spring feature; and coiling the selected wire so as to form the optimal torsion spring.

For instance, at least one of a coiling direction, a wire diameter, a coil diameter (i.e., an average diameter of the coils forming the spring), a tightness of the coils (i.e., an average distance between adjacent coils forming the spring) and a length, or free length (i.e., a length of the spring when at rest) is a function of said at least one blind parameter. For instance, at least one dimension of the optimal torsion spring is a function of dimensions of the mechanism-receiving cavity.

There is also provided a method for assembling the spring-assisted roller blind mechanism of said roller blind system, the method comprising: providing the optimal torsion spring manufactured according to the present disclosure; and at least partially engaging a first end portion of the optimal torsion spring to said spring-engaging portion to assemble the spring-assisted roller blind mechanism.

Several alternative embodiments and examples have been described and illustrated herein. The embodiments described above are intended to be exemplary only. A person of ordinary skill in the art would appreciate the features of the individual embodiments, and the possible combinations and variations of the components. A person of ordinary skill in the art would further appreciate that any of the embodiments could be provided in any combination with the other embodiments disclosed herein. It is understood that the invention may be embodied in other specific forms without departing from the central characteristics thereof. The present examples and embodiments, therefore, are to be considered in all respects as illustrative and not restrictive, and the invention is not to be limited to the details given herein. Accordingly, while the specific embodiments have been illustrated and described, numerous modifications come to mind. The scope of the invention is therefore intended to be defined by the scope of the appended claims.

What is claimed is:

1. A method for assembling a spring-assisted roller blind mechanism for a roller blind system comprising a roller blind tube assembly, the roller blind tube assembly comprising a roller blind tube and a blind mounted thereto, the spring-assisted roller blind mechanism comprising a spring-engaging portion and being operatively couplable to the roller blind tube to configure the blind in wound and unwound configurations, the method comprising:
determining at least one optimal spring feature as a function of at least one blind parameter of the roller blind system;
selecting a torsion spring as a function of said at least one determined optimal spring feature;
determining an installation length of the selected torsion spring;
substantially conforming a length of the selected torsion spring to the determined installation length to provide an adjusted torsion spring; and
at least partially engaging a first end portion of the adjusted torsion spring to said spring-engaging portion of the spring-assisted roller blind mechanism to assemble the spring-assisted roller blind mechanism.

2. The method according to claim 1, the roller blind tube defining a mechanism-receiving cavity, wherein the method further comprises at least partially inserting the assembled spring-assisted roller blind mechanism into the mechanism-receiving cavity.

3. The method according to claim 1, wherein said at least one blind parameter of the roller blind system comprises at least one of a length of the roller blind tube assembly, an outer diameter of the roller blind tube, at least one blind parameter of the blind, a weight of the roller blind tube assembly and a number of rotations of said roller blind tube to be configured from one of the unwound and wound configurations to the other.

4. The method according to claim 3, wherein said at least one blind parameter of the blind comprises at least one of a length, a width, a surface weight and a thickness of said blind.

5. The method according to claim 1, wherein substantially conforming the length of the selected torsion spring to the determined installation length comprises splitting the selected torsion spring into an adjusted torsion spring portion and a residual portion.

6. The method according to claim 5, wherein splitting the selected torsion spring into the adjusted torsion spring portion and the residual portion comprises:
marking a segment of a coil of the selected torsion spring at the determined installation length to identify a marked location of the torsion spring to be cut; and
cutting the torsion spring at the marked location.

7. The method according to claim 1, the selected torsion spring having an initial length, wherein the installation length is smaller than 90% of the initial length.

8. The method according to claim 1, wherein determining said at least one optimal spring feature comprises determining at least one of an optimal spring stiffness and an optimal spring preload.

9. The method according to claim 1, wherein selecting the torsion spring as a function of said at least one determined optimal spring feature comprises verifying that the selected torsion spring complies with at least one predetermined criteria.

10. A method for manufacturing an optimal torsion spring for a spring-assisted roller blind mechanism of a roller blind system, the method comprising:
determining at least one optimal spring feature as a function of at least one blind parameter of the roller blind system;
selecting a wire as a function of said at least one determined optimal spring feature; and
coiling the selected wire so as to form the optimal torsion spring.

11. The method according to claim 10, wherein the roller blind system comprises a roller blind tube assembly, the roller blind tube assembly comprising a roller blind tube and a blind mounted thereto, the spring-assisted roller blind mechanism being operatively coupled to the roller blind tube to configure the blind in wound and unwound configurations, wherein said at least one blind parameter comprises at least one of a length of the roller blind tube assembly, an outer diameter of the roller blind tube, at least one blind parameter of the blind, a weight of the roller blind tube assembly and a number of rotations of said roller blind tube to be configured from one of the unwound and wound configurations to the other.

12. The method according to claim 11, wherein said at least one blind parameter comprises at least one of a length, a width, a surface weight and a thickness of said blind.

13. The method according to claim 11, wherein a coiling direction of the optimal torsion spring is a function of said at least one blind parameter.

14. The method according to claim 11, wherein the roller blind tube defines a mechanism-receiving cavity, and wherein at least one dimension of the optimal torsion spring is a function of dimensions of the mechanism-receiving cavity.

15. A method for assembling a spring-assisted roller blind mechanism for a roller blind system, the spring-assisted roller blind mechanism comprising a spring-engaging portion, the method comprising:
providing the optimal torsion spring manufactured according to the method of claim 11; and
at least partially engaging a first end portion of the optimal torsion spring to said spring-engaging portion to assemble the spring-assisted roller blind mechanism.

16. A method for assembling a spring-assisted roller blind mechanism for a roller blind system comprising a roller blind tube assembly, the roller blind tube assembly comprising a roller blind tube and a blind mounted thereto, the spring-assisted roller blind mechanism comprising a spring-engaging portion and being operatively couplable to the roller blind tube to configure the blind in wound and unwound configurations, the method comprising:
determining at least one optimal spring feature as a function of at least one blind parameter of the roller blind system;
determining a spring length;
providing a plurality of torsion springs;
selecting a torsion spring within said plurality of torsion springs as a function of said at least one determined optimal spring feature and said determined spring length; and
at least partially engaging a first end portion of the adjusted torsion spring to said spring-engaging portion to assemble the spring-assisted roller blind mechanism.
